(19) United States
(12) Patent Application Publication
(10) Pub. No.: US 2024/0021865 A1
(43) Pub. Date: Jan. 18, 2024

(54) FREE-STANDING, THIN ELECTROLYTE LAYERS

(71) Applicant: GM GLOBAL TECHNOLOGY OPERATIONS LLC, Detroit, MI (US)

(72) Inventors: Zhe LI, Shanghai (CN); Meiyuan WU, Shanghai (CN); Qili SU, Shanghai (CN); Yong LU, Shanghai (CN); Haijing LIU, Shanghai (CN)

(73) Assignee: GM GLOBAL TECHNOLOGY OPERATIONS LLC, Detroit, MI (US)

(21) Appl. No.: 17/939,527

(22) Filed: Sep. 7, 2022

(30) Foreign Application Priority Data
Jul. 12, 2022 (CN) 202210815508.1

(51) Int. Cl. H01M 10/0562; H01M 10/0525; H01M 10/058

(52) U.S. Cl. CPC H01M 10/0562; H01M 10/0525; H01M 10/058; H01M 2300/008

(57) ABSTRACT

An electrochemical cell that includes a first electrode, a second electrode, and an electrolyte layer that is disposed between the first electrode and the second electrode is provided. The electrolyte layer includes a porous scaffold having a porosity greater than or equal to about 50 vol. % to less than or equal to about 90 vol. %, and a solution-processable solid-state electrolyte that at least partially fills the pores of the porous scaffold. The porous scaffold is defined by a plurality of fibers having an average diameter greater than or equal to about 0.01 micrometer to less than or equal to about 10 micrometers and an average length greater than or equal to about 1 micrometer to less than or equal to about 20 micrometers. The solution-processable solid-state electrolyte includes is selected from the group consisting of: sulfide-based solid-state particles, halide-based solid-state particles, hydride-based solid-state particles, and combinations thereof.

### CROSS-REFERENCE TO RELATED APPLICATIONS

This application claims the benefit and priority of Chinese Application No. 202210815508.7 filed Jul. 12, 2022. The entire disclosure of the above application is incorporated herein by reference.

### INTRODUCTION

This section provides background information related to the present disclosure which is not necessarily prior art.

Electrochemical energy storage devices, such as lithium-ion batteries, can be used in a variety of products, including automotive products such as start-stop systems (e.g., 12V start-stop systems), battery-assisted systems (“μBAS”), Hybrid Electric Vehicles (“HEVs”), and Electric Vehicles (“EVs”). Typical lithium-ion batteries include two electrodes and an electrolyte component and/or separator. One of the two electrodes can serve as a positive electrode or cathode, and the other electrode can serve as a negative electrode or anode. Lithium-ion batteries may also include various terminal and packaging materials. Rechargeable lithium-ion batteries operate by reversibly passing lithium ions back and forth between the negative electrode and the positive electrode. For example, lithium ions may move from the positive electrode to the negative electrode during charging of the battery and in the opposite direction when discharging the battery.

A separator and/or electrolyte may be disposed between the negative and positive electrodes. The electrolyte is suitable for conducting lithium ions between the electrodes and, like the two electrodes, may be in a solid form, a liquid form, or a solid-liquid hybrid form. In the instances of solid-state or semi-solid-state batteries, which includes a solid-state or semi-solid-state electrolyte layer disposed between solid-state or semi-solid-state electrodes, the solid-state or semi-solid-state electrolyte layer physically separates the solid-state or semi-solid-state electrodes so that a distinct separator is not required. Solid-state electrolyte layer, like sulfide-base solid-state electrolyte layers often have larger thicknesses (e.g., greater than or equal to about 500 micrometers (μm) to less than or equal to about 1 mm), decreasing the overall energy density and power capability of the battery at least in part because of the longer lithium ion conduction path. Such solid-state electrolytes are also often suited only for use at low currents (e.g., 0.05 C-rate) and comparatively high temperatures (e.g., 60° C.). Accordingly, it would be desirable to develop electrolyte layers having high conductivities and reduced thicknesses, as well as improved mechanical properties, for solid-state and semi-solid-state batteries.

### SUMMARY

This section provides a general summary of the disclosure, and is not a comprehensive disclosure of its full scope or all of its features.

The present disclosure relates to electrolyte layers for electrochemical cells that cycle lithium ions, and methods of making and using the same. The electrolyte layers are, for example, free-standing, thin electrolyte layers including porous scaffolds and solution-processable solid-state electrolyte disposed therein.

In various aspects, the present disclosure provides an electrolyte layer for use in an electrochemical cell that cycles lithium ions. The electrolyte layer may include a porous scaffold and a solution-processable solid-state electrolyte that at least partially fills pores of the porous scaffold.

In one aspect, the porous scaffold may be defined by a plurality of fibers. The fibers in the plurality may have an average diameter greater than or equal to about 0.01 micrometer to less than or equal to about 10 micrometers and an average length greater than or equal to about 1 micrometer to less than or equal to about 20 micrometers.

In one aspect, the porous scaffold may have a porosity greater than or equal to about 50 vol. % to less than or equal to about 90 vol. %.

In one aspect, the porous scaffold may be a high-temperature stable membrane.

In one aspect, the porous scaffold may have an average thickness greater than or equal to about 5 micrometers to less than or equal to about 40 micrometers.

In one aspect, the solution-processable solid-state electrolyte may be selected from the group consisting of: sulfide-based solid-state particles, halide-based solid-state particles, hydride-based solid-state particles, and combinations thereof

In one aspect, the solution-processable solid-state electrolyte may include sulfide-based solid-state particles.

In one aspect, the solution-processable solid-state electrolyte may include argyrodite solid-state particles.

In one aspect, the electrolyte layer may have an average thickness greater than or equal to about 5 micrometers to less than or equal to about 60 micrometers.

In various aspects, the present disclosure may provide an electrochemical cell that cycles lithium ions. The electrochemical cell may include a first electrode, a second electrode, and an electrolyte layer that is disposed between the first electrode and the second electrode. The electrolyte layer may include a porous scaffold having a porosity greater than or equal to about 50 vol. % to less than or equal to about 90 vol. %, and a solution-processable solid-state electrolyte that at least partially fills the pores of the porous scaffold.

In one aspect, the porous scaffold may be defined by a plurality of fibers. The fibers in the plurality may have an average diameter greater than or equal to about 0.01 micrometer to less than or equal to about 10 micrometers and an average length greater than or equal to about 1 micrometer to less than or equal to about 20 micrometers.

In one aspect, the porous scaffold may be a high-temperature stable membrane.

In one aspect, the porous scaffold may have an average thickness greater than or equal to about 5 micrometers to less than or equal to about 40 micrometers, and the electrolyte layer may have an average thickness greater than or equal to about 5 micrometers to less than or equal to about 60 micrometers.

In one aspect, the solution-processable solid-state electrolyte may be selected from the group consisting of: sulfide-based solid-state particles, halide-based solid-state particles, hydride-based solid-state particles, and combinations thereof

In various aspects, the present disclosure provides a method for preparing an electrolyte layer for an electrochemical cell that cycles lithium ions. The method may include contacting a precursor solution to a porous scaffold, where the precursor solution includes a solution-processable solid-state electrolyte and a solvent. The method may also include removing the solvent to form the electrolyte layer. The electrolyte layer includes the porous scaffold, which has a porosity greater than or equal to about 50 vol. % to less than or equal to about 90 vol. %, and the solution-processable solid-state electrolyte, which at least partially filling pores of the porous scaffold.

In one aspect, the porous scaffold may be defined by a plurality of fibers. The fibers in the plurality may have an average diameter greater than or equal to about 0.01 micrometer to less than or equal to about 10 micrometers and an average length greater than or equal to about 1 micrometer to less than or equal to about 20 micrometers.

In one aspect, the porous scaffold may be a high-temperature stable membrane.

In one aspect, the porous scaffold may have an average thickness greater than or equal to about 5 micrometers to less than or equal to about 40 micrometers, and the electrolyte layer may have an average thickness greater than or equal to about 5 micrometers to less than or equal to about 60 micrometers.

In one aspect, the solution-processable solid-state electrolyte may be selected from the group consisting of: sulfide-based solid-state particles, halide-based solid-state particles, hydride-based solid-state particles, and combinations thereof

In one aspect, the solvent may be removed by heating the porous scaffold and the precursor solution to greater than or equal to about 60° C. to less than or equal to about 300° C. for a period greater than or equal to about 0.1 hour to less than or equal to about 12 hours.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1 is an illustration of an example electrochemical cell including an electrolyte layer including a porous scaffold and a solution-processable solid-state electrolyte in accordance with various aspects of the present disclosure;

FIG. 2 is a scanning electron microscopy image (scale: 10 μm) of a porous scaffold in accordance with various aspects of the present disclosure;

FIG. 3 is a scanning electron microscopy image (scale: 2 μm) of an electrolyte layer including a porous scaffold and a solution-processable solid-state electrolyte in accordance with various aspects of the present disclosure;

FIG. 4A is a graphical illustration demonstrating the x-ray diffraction (XRD) measurements for an example electrolyte layer including a porous scaffold and a solution-processable solid-state electrolyte in accordance with various aspects of the present disclosure; and

FIG. 4B is a graphical illustration demonstrating the Raman spectroscopy for an example electrolyte layer including a porous scaffold and a solution-processable solid-state electrolyte in accordance with various aspects of the present disclosure.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected, or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer, or section. Terms such as “first,” “second,” and other numerical terms when used herein do not imply a sequence or order unless clearly indicated by the context. Thus, a first step, element, component, region, layer, or section discussed below could be termed a second step, element, component, region, layer, or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates both exactly or precisely the stated numerical value, and also, that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Example embodiments will now be described more fully with reference to the accompanying drawings.

The current technology pertains to solid-state batteries (SSBs) including free-standing, thin electrolyte layers and methods of forming and using the same. Solid-state batteries may include at least one solid component, for example, at least one solid electrode, but may also include, in certain variations, semi-solid or gel, liquid, or gas components. In various instances, solid-state batteries may have a bipolar stacking design comprising a plurality of bipolar electrodes where a first mixture of solid-state electroactive material particles (and optional solid-state electrolyte particles) is disposed on a first side of a current collector, and a second mixture of solid-state electroactive material particles (and optional solid-state electrolyte particles) is disposed on a second side of a current collector that is parallel with the first side. The first mixture may include, as the solid-state electroactive material particles, cathode material particles. The second mixture may include, as solid-state electroactive material particles, anode material particles. The solid-state electrolyte particles in each instance may be the same or different.

In other variations, the solid-state batteries may have a monopolar stacking design comprising a plurality of monopolar electrodes where a first mixture of solid-state electroactive material particles (and optional solid-state electrolyte particles) is disposed on both a first side and a second side of a first current collector, wherein the first and second sides of the first current collector are substantially parallel, and a second mixture of solid-state electroactive material particles (and optional solid-state electrolyte particles) is disposed on both a first side and a second side of a second current collector, where the first and second sides of the second current collector are substantially parallel. The first mixture may include, as the solid-state electroactive material particles, cathode material particles. The second mixture may include, as solid-state electroactive material particles, anode material particles. The solid-state electrolyte particles in each instance may be the same or different. In certain variations, solid-state batteries may include a mixture of combination of bipolar and monopolar stacking designs.

Such solid-state batteries may be incorporated into energy storage devices, like rechargeable lithium-ion batteries, which may be used in automotive transportation applications (e.g., motorcycles, boats, tractors, buses, mobile homes, campers, and tanks). The present technology, however, may also be used in other electrochemical devices, including aerospace components, consumer goods, devices, buildings (e.g., houses, offices, sheds, and warehouses), office equipment and furniture, and industrial equipment machinery, agricultural or farm equipment, or heavy machinery, by way of non-limiting example. In various aspects, the present disclosure provides a rechargeable lithium-ion battery that exhibits high temperature tolerance, as well as improved safety and superior power capability and life performance.

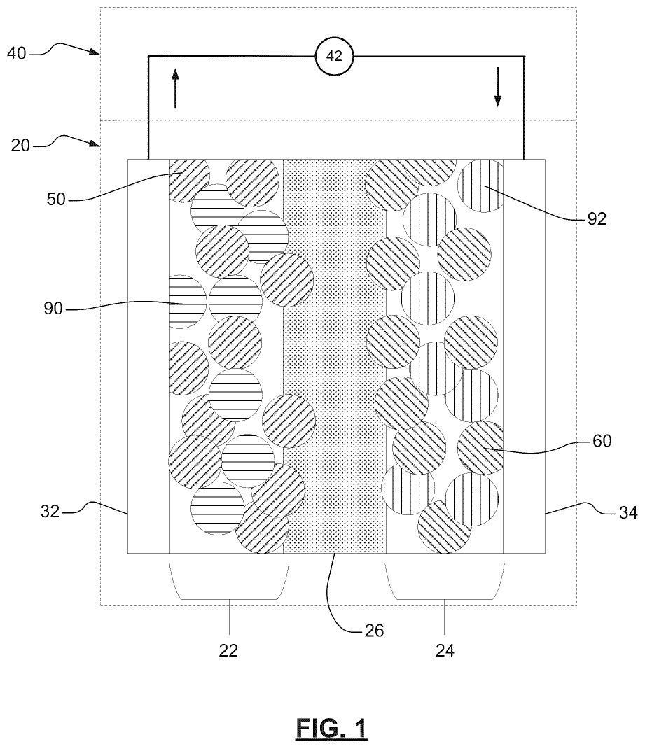

An exemplary and schematic illustration of a solid-state electrochemical cell unit (also referred to as a “solid-state battery” and/or “battery”) 20 that cycles lithium ions is shown in FIG. 1. The battery 20 includes a negative electrode (i.e., anode) 22, a positive electrode (i.e., cathode) 24, and an electrolyte layer 26 that occupies a space defined between the two or more electrodes 22, 24. The electrolyte layer 26 is a solid-state separating layer that physically separates the negative electrode 22 from the positive electrode 24. As further discussed below, the electrolyte layer 26 may be a free-standing, thin electrolyte membrane that includes a porous scaffold and a solution-processable solid-state electrolyte disposed therein.

A first current collector 32 may be positioned at or near the negative electrode 22. The first current collector 32 may be a metal foil, metal grid or screen, or expanded metal comprising copper or any other appropriate electrically conductive material known to those of skill in the art. A second current collector 34 may be positioned at or near the positive electrode 24. The second current collector 34 may be a metal foil, metal grid or screen, or expanded metal comprising aluminum or any other appropriate electrically conductive material known to those of skill in the art. The first current collector 32 and the second current collector 34 may be the same or different. The first current collector 32 and the second electrode current collector 34 respectively collect and move free electrons to and from an external circuit 40. For example, an interruptible external circuit 40 and a load device 42 may connect the negative electrode 22 (through the first current collector 32) and the positive electrode 24 (through the second current collector 34).

Although not illustrated, the skilled artisan will recognize that in certain variations, the first current collector 32 may be a first bipolar current collector and/or the second current collector 34 may be a second bipolar current collector. For example, the first bipolar current collector 34 and/or the second bipolar current collector 34 may be cladded foils, for example, where one side (e.g., the first side or the second side) of the current collector 32, 34 includes one metal (e.g., first metal) and another side (e.g., the other side of the first side or the second side) of the current collector 32 includes another metal (e.g., second metal). In certain variations, the cladded foils may include, for example only, aluminum-copper (Al-Cu), nickel-copper (Ni-Cu), stainless steel-copper (SS-Cu), aluminum-nickel (Al-Ni), aluminum-stainless steel (Al-SS), and nickel-stainless steel (Ni-SS). In certain variations, the first bipolar current collector 32 and/or second bipolar current collectors 34 may be pre-coated including, for example, graphene or carbon-coated aluminum current collectors.

The battery 20 can generate an electric current (indicated by arrows in FIG. 1) during discharge by way of reversible electrochemical reactions that occur when the external circuit 40 is closed (to connect the negative electrode 22 and the positive electrode 24) and when the negative electrode 22 has a lower potential than the positive electrode 24. The chemical potential difference between the negative electrode 22 and the positive electrode 24 drives electrons produced by a reaction, for example, the oxidation of intercalated lithium, at the negative electrode 22, through the external circuit 40 towards the positive electrode 24. Lithium ions, which are also produced at the negative electrode 22, are concurrently transferred through the electrolyte layer 26 towards the positive electrode 24. The electrons flow through the external circuit 40 and the lithium ions migrate across the electrolyte layer 26 to the positive electrode 24, where they may be plated, reacted, or intercalated. The electric current passing through the external circuit 40 can be harnessed and directed through the load device 42 (in the direction of the arrows) until the lithium in the negative electrode 22 is depleted and the capacity of the battery 20 is diminished.

The battery 20 can be charged or reenergized at any time by connecting an external power source (e.g., charging device) to the battery 20 to reverse the electrochemical reactions that occur during battery discharge. The external power source that may be used to charge the battery 20 may vary depending on the size, construction, and particular end-use of the battery 20. Some notable and exemplary external power sources include, but are not limited to, an AC-DC converter connected to an AC electrical power grid though a wall outlet and a motor vehicle alternator. The connection of the external power source to the battery 20 promotes a reaction, for example, non-spontaneous oxidation of intercalated lithium, at the positive electrode 24 so that electrons and lithium ions are produced. The electrons, which flow back towards the negative electrode 22 through the external circuit 40, and the lithium ions, which move across the electrolyte layer 26 back towards the negative electrode 22, reunite at the negative electrode 22 and replenish it with lithium for consumption during the next battery discharge cycle. As such, a complete discharging event followed by a complete charging event is considered to be a cycle, where lithium ions are cycled between the positive electrode 24 and the negative electrode 22.

Although the illustrated example includes a single positive electrode 24 and a single negative electrode 22, the skilled artisan will recognize that the current teachings apply to various other configurations, including those having one or more cathodes and one or more anodes, as well as various current collectors and current collector films with electroactive particle layers disposed on or adjacent to or embedded within one or more surfaces thereof. Likewise, it should be recognized that the battery 20 may include a variety of other components that, while not depicted here, are nonetheless known to those of skill in the art. For example, the battery 20 may include a casing, a gasket, terminal caps, and any other conventional components or materials that may be situated within the battery 20, including between or around the negative electrode 22, the positive electrode 24, and/or the electrolyte 26 layer.

In many configurations, each of the first current collector 32, the negative electrode 22, the electrolyte layer 26, the positive electrode 24, and the second current collector 34 are prepared as relatively thin layers (for example, from several microns to a millimeter or less in thickness) and assembled in layers connected in series arrangement to provide a suitable electrical energy, battery voltage and power package, for example, to yield a Series-Connected Elementary Cell Core (“SECC”). In various other instances, the battery 20 may further include electrodes 22, 24 connected in parallel to provide suitable electrical energy, battery voltage, and power for example, to yield a Parallel-Connected Elementary Cell Core (“PECC”).

The size and shape of the battery 20 may vary depending on the particular application for which it is designed. Battery-powered vehicles and hand-held consumer electronic devices are two examples where the battery 20 would most likely be designed to different size, capacity, voltage, energy, and power-output specifications. The battery 20 may also be connected in series or parallel with other similar lithium-ion cells or batteries to produce a greater voltage output, energy, and power if it is required by the load device 42. The battery 20 can generate an electric current to the load device 42 that can be operatively connected to the external circuit 40. The load device 42 may be fully or partially powered by the electric current passing through the external circuit 40 when the battery 20 is discharging. While the load device 42 may be any number of known electrically-powered devices, a few specific examples of power-consuming load devices include an electric motor for a hybrid vehicle or an all-electric vehicle, a laptop computer, a tablet computer, a cellular phone, and cordless power tools or appliances, by way of non-limiting example. The load device 42 may also be an electricity-generating apparatus that charges the battery 20 for purposes of storing electrical energy.

With renewed reference to FIG. 1, the electrolyte layer 26 may be a free-standing, thin electrolyte membrane that includes a porous scaffold and a solution-processable solid-state electrolyte disposed therein. For example, the electrolyte layer 26 may include greater than or equal to about 5 wt. % to less than or equal to about 50 wt. %, and in certain aspects, optionally greater than or equal to about 10 wt. % to less than or equal to about 50 wt. %, of the porous scaffold; and greater than or equal to about 50 wt. % to less than or equal to about 95 wt. %, optionally greater than or equal to about 50 wt. % to less than or equal to about 90 wt. %, and in certain aspects, optionally greater than or equal to about 60 wt. % to less than or equal to about 90 wt. %, of the s ol uti on-processable solid-state electrolyte.

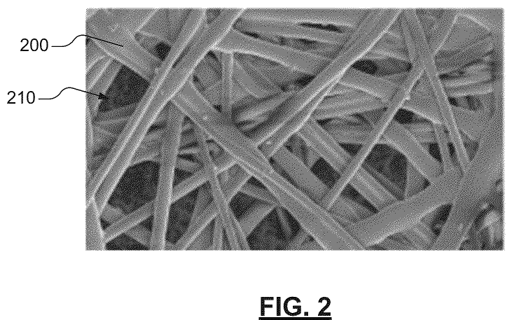

As illustrated n FIG. 2, the porous scaffold may include a plurality of fibers 200 that define a plurality of pores 210. The fibers 200 may have, for example, average diameters greater than or equal to about 0.01 micrometer (μm) to less than or equal to about 10 μm, and in certain aspects, optionally greater than or equal to about 0.01 μm to less than or equal to about 5 μm. The fibers 200 may have, for example, average lengths greater than or equal to about 1 μm to less than or equal to about 20 μm, and in certain aspects, optionally greater than or equal to about 1 μm to less than or equal to about 10 μm. The porous scaffold may have a porosity greater than or equal to about 50 vol. % to less than or equal to about 90 vol. %, and in certain aspects, optionally greater than or equal to about 60 vol. % to less than or equal to about 90 vol. %.

The porous scaffold may have a high heat resistance (e.g., greater than or equal to about 200° C.), which allows, for example, different membrane fabrication processes that generally include heat treatments at about 150° C. The porous scaffold may also have good flexibility and toughness. In certain variations, the porous scaffold may include a porous polyester nonwoven scaffold. In other variations, the porous scaffold may include, for example, cellulose separators, polyvinylidene fluoride (PVdF) membranes, polyimide membranes. In still other variations, the porous scaffold may include, for example, a polyolefin-based separator. The polyolefin-based separator may include, for example, polyacetylene, polypropylene, and/or polyethylene (e.g., dual-layered separators: polypropylene:polyethylene and/or three-layered separators: polypropylene:polyethylene:polypropylene). In further variations, the porous scaffold may be a ceramic-coated membrane (e.g., silica (SiO₂) coated polyethylene). In still further variations, the porous scaffold may be a high-temperature-stable (e.g., above about 80° C.) porous member (e.g., polyimide nanofiber-based nonwovens, co-polyimide-coated polyethylene separators, expanded polytetrafluoroethylene reinforced polyvinylidenefluoride-hexafluoropropylene separator; sandwich-structure polyvinylidene fluoride (PVdF): poly(m-phenylene isophthalamide) (PMIA): polyvinylidene fluoride (PVdF) nanofibrous separators, and the like). In certain variations, the porous scaffold may include a combination of any of the above listed scaffolds.

The solution-processable solid-state electrolyte is one that can sufficiently infiltrate the porous scaffold while in solution form. For example, the solution-processable solid-state electrolyte may infiltrate greater than or equal to about 80 vol. % to less than or equal to about 400 vol. %, and in certain aspects, optionally greater than or equal to about 80 vol. % to less than or equal to about 300 vol. %, of a total pore space of the porous scaffold. The solution-processable solid-state electrolyte may include, for example, sulfide-based solid-state particles. The sulfide-based solid-state particles may include pseudobinary sulfides (including, for example, Li₂S—P₂S₅ systems (such as, Li₃PS₄, Li₇P₃S₁₁, and Li_{9.6}P₃S₁₂), Li₂S—SnS₂ systems (such as, Li₄SnS₄), Li₂S—SiS₂ systems, Li₂S—GeS₂ systems, Li₂S—B₂S₃ systems, Li₂S—Ga₂S₃ systems, Li₂S—P₂S₃ systems, and/or Li₂S—Al₂S₃ systems), pseudoternary sulfides (including, for example, Li₂O—Li₂S—P₂S₅ systems, Li₂S—P₂S₅ —P₂O₅ systems, Li₂S—P₂S₅ —GeS₂ systems (such as, Li_{3.25}Ge_{0.25}P_{0.75}S₄ and Li₁₀GeP₂Si₂), Li₂S—P₂S₅—LiX systems (where X is F, Cl, Br, or I) (such as, Li₆PS₅Br, Li₆PS₅Cl, Li₇P₂S₈I, and Li₄PS₄I), Li₂S—As₂S₅—SnS₂ systems (such as, Li_{3.8333}AS_{0.166}S₄), Li₂S—P₂S₅ —Al₂S₃ systems, Li₂S—LiX—SiS₅ systems (where X is F, I, Br, or I), 0.4LiI·0.6Li₄SnS₄, and/or Li₁₁Si₂PSi₂), and/or pseudoquaternary sulfides (including, for example, Li₂O—Li₂S—P₂S₅ —P₂O₅ systems, Li_{9.54}Si_{1.74}P_{1.44}S_{11.7}Cl_{0.3}, Li₇P_{2.9}Mn_{0.1}S_{10.7}I_{0.3}, and Li_{10.35}[Sn_{0.27}Si_{1.08}]P_{1.65}S₁₂).

In certain variations, the solution-processable solid-state electrolyte may be a solution-processable argyrodite sulfide electrolyte (e.g., Li₆PS₅Br).

In other variations, the solution-processable solid-state electrolyte may include, for example, halide-based solid-state particles. The halide-based solid-state particles may include Li₃YCl₆, Li₃InCl₆, Li₃YBr₆, LiI, Li₂CdCl₄, Li₂MgCl₄, LiCdI₄, Li₂ZnI₄, Li₃OCl, and combinations thereof. In still other variations, the solution-processable solid-state electrolyte may include, for example, hydride-based solid-state particles. The hydride-based solid-state particles may include LiBH₄, LiBH₄—LiX (where x=Cl, Br, or I), LiNH₂, Li₂NH, LiBH₄—LiNH₂, Li₃AlH₆, and combinations thereof. In still further variations, the solution-processable solid-state electrolyte may include a combination of sulfide-based solid-state particles, halide-based solid-state particles, hydride-based solid-state particles, and/or other solid-state electrolytes that can be prepared by a solution-based process. In each variation, the solution-processable solid-state electrolyte may be dissolvable in a solvent so as to form a precursor solution. The solvent may include, for example, a tetrahydrofuran, ethyl propionate, ethylacetate, acetonitrile, water, N-methyl formamide, methanol, ethanol, ethanol-tetrahydrofuran co-solvent, and/or 1,2-dimethoxyethane. As further detailed below, the solvent may be removed from the precursor solution so as to facilitate precipitation of the solution-processable solid-state electrolyte within pores of the porous scaffold.

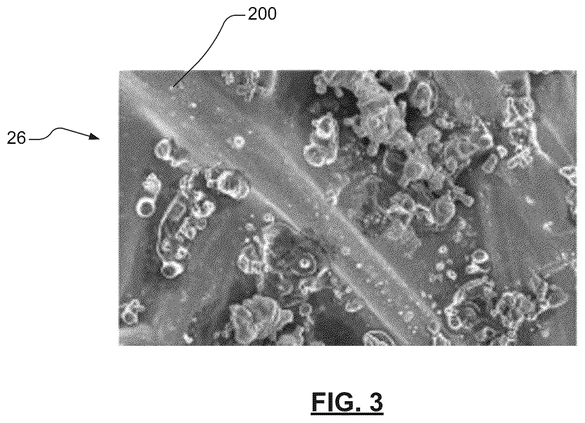

FIG. 3 is a scanning a scanning electron microscopy image (scale: 2 μm) of the electrolyte layer 26. As illustrated, the electrolyte layer 26 has no noticeable cracks or voids. The solution-processable solid-state electrolyte may fill, for example, greater than or equal to about 50% to less than or equal to about 300%, and in certain aspects, optionally greater than or equal to about 60% to less than or equal to about 200%, of a total porosity of the porous scaffold. The porous scaffold may have an average thickness greater than or equal to about 5 μm to less than or equal to about 40 μm, and in certain aspects, optionally greater than or equal to about 5 μm to less than or equal to about 25 μm. The porous scaffold may experience a thickness extension (e.g., greater than or equal to about 100% to less than or equal to about 150%) upon the introduction of the solution-processable solid-state electrolyte. For example, the electrolyte layer 26 may have an average thickness greater than or equal to about 5 μm to less than or equal to about 60 μm, and in certain aspects, optionally about 14 μm. The electrolyte layer 26 may have an areal conductance of about 7 mS/cm² , which is similar to the areal conductance of a Li₆PS₅Br sulfide pellet.

With renewed reference to FIG. 1, the negative electrode 22 may be formed from a lithium host material that is capable of functioning as a negative terminal of a lithium-ion battery. For example, in certain variations, the negative electrode 22 may be defined by a plurality of the negative solid-state electroactive particles 50. In certain instances, as illustrated, the negative electrode 22 is a composite comprising a mixture of the negative solid-state electroactive particles 50 and a first plurality of solid-state electrolyte particles 90. For example, the negative electrode 22 may include greater than or equal to about 30 wt. % to less than or equal to about 98 wt. %, and in certain aspects, optionally greater than or equal to about 50 wt. % to less than or equal to about 95 wt. %, of the negative solid-state electroactive particles 50, and greater than or equal to 0 wt. % to less than or equal to about 50 wt. %, and in certain aspects, optionally greater than or equal to about 5 wt. % to less than or equal to about 20 wt. %, of the first plurality of solid-state electrolyte particles 90. In each variation, the negative electrode 22 may be in the form of a layer having an average thickness greater than or equal to about 10 μm to less than or equal to about 5,000 μm, and in certain aspects, optionally greater than or equal to about 10 μm to less than or equal to about 200 μm.

The negative solid-state electroactive particles 50 may be lithium-based, for example, a lithium alloy or lithium metal. In other variations, the negative solid-state electroactive particles 50 may be silicon-based comprising, for example, a silicon alloy and/or silicon-graphite mixture. In still other variations, the negative electrode 22 may be a carbonaceous anode and the negative solid-state electroactive particles 50 may comprise one or more negative electroactive materials, such as graphite, graphene, hard carbon, soft carbon, and carbon nanotubes (CNTs). In still further variations, the negative electrode 22 may comprise one or more negative electroactive materials, such as lithium titanium oxide (Li₄Ti₅O₁₂); one or more metal oxides, such as TiO2 and/or V₂O₅; and/or metal sulfides, such as FeS. The negative solid-state electroactive particles 50 may be selected from the group including, for example only, lithium, graphite, graphene, hard carbon, soft carbon, carbon nanotubes, silicon, silicon-containing alloys, tin-containing alloys, and/or other lithium-accepting materials.

The first plurality of solid-state electrolyte particles 90 are selected so as to have a high ionic conductivity. For example, the solid-state electrolyte particles 90 may have an ionic conductivity greater than or equal to about 0.1 mS/cm to less than or equal to about 20 mS/cm, and in certain aspects, optionally greater than or equal to about 0.1 mS/cm to less than or equal to about 5 mS/cm, at room temperature (i. greater than or equal to about 20° C. to less than or equal to about 22° C.). In certain variations, the solid-state electrolyte particles 00 may have an average particle diameter greater than or equal to about 0.02 μm to less than or equal to about 20 μm, optionally greater than or equal to about 0.1 μm to less than or equal to about 10 μm, and in certain aspects, optionally greater than or equal to about 0.1 μm to less than or equal to about 1 μm.

In certain variations, the solid-state electrolyte particles 90 may include, for example, sulfide-based solid-state particles. The sulfide-based solid-state particles may include pseudobinary sulfides (including, for example, Li₂S—P₂S₅ systems (such as, Li₃PS₄, Li₇P₃S₁₁, and Li_{9.6}P₃S₁₂), Li₂S—SnS₂ systems (such as, Li₄SnS₄), Li₂S—SiS₂ systems, Li₂S—GeS₂ systems, Li₂S—B₂S₃ systems, Li₂S—Ga₂S₃ systems, Li₂S—P₂S₃ systems, and/or Li₂S—Al₂S₃ systems), pseudoternary sulfides (including, for example, Li₂O—Li₂S—P₂S₅ systems, Li₂S—P₂S₅ —P₂O₅ systems, Li₂S—P₂S₅ —GeS₂ systems (such as, Li_{3.25}Ge_{0.25}P_{0.75}S₄ and Li₁₀GeP₂S₁₂), Li₂S—P₂S₅ —LiX systems (where X is F, Cl, Br, or I) (such as, Li₆PS₅Br, Li₆PS₅Cl, Li₇P₂S₈I, and Li₄PS₄I), Li₂S—As₂S₅—SnS₂ systems (such as, Li_{3.8333}As_{0.166}S₄), Li₂S—P₂S₅ —Al₂S₃ systems, Li₂S—LiX—SiS₅ systems (where X is F, I, Br, or I), 0.4LiI·0.6Li₄SnS₄, and/or Li₁₁Si₂PSi₂), and/or pseudoquaternary sulfides (including, for example, Li₂O—Li₂S—P₂S₅ —P₂O₅ systems, Li_{9.54}Si_{1.74}P_{1.44}S_{11.7}Cl_{0.3}, Li₇P_{2.9}Mn_{0.1}S_{10.7}I_{0.3}, and Li_{10.35}[Sn_{0.27}Si_{1.08}]P_{1.65}S₁₂).

In other variations, the solid-state electrolyte particles 90 may include, for example, halide-based solid-state particles. The halide-based solid-state particles may include Li₃YCl₆, Li₃InCl₆, Li₃YBr₆, LiI, Li₂CdCl₄, Li₂MgCl₄, LiCdI₄, Li₂ZnI₄, Li₃OCl, and combinations thereof. In still other variations, the solid-sate electrolyte particles 90 may include, for example, hydride-based solid-state particles. The hydride-based solid-state particles may include LiBH₄, LiBH₄—LiX (where x=Cl, Br, or I), LiNH₂, Li₂NH, LiBH₄—LiNH₂, Li₃AlH₆, and combinations thereof. In still further variations, the solid-state electrolyte particles 90 may include a combination of sulfide-based solid-state particles, halide-based solid-state particles, hydride-based solid-state particles, and/or other low grain-boundary resistance solid-state electrolyte particles.

Although not illustrated, in certain variations, the negative electrode 22 may further include one or more conductive additives and/or binder materials. The negative solid-state electroactive particles 50 (and/or the optional first plurality of solid-state electrolyte particles 90) may be optionally intermingled with one or more electrically conductive materials (not shown) that provide an electron conduction path and/or at least one polymeric binder material (not shown) that improves the structural integrity of the negative electrode 22. For example, the negative electrode may include greater than or equal to 0 wt. % to less than or equal to about 30 wt. %, and in certain aspects, optionally greater than or equal to about 2 wt. % to less than or equal to about 10 wt. %, of the one or more electrically conductive additives; and greater than or equal to 0 wt. % to less than or equal to about 20 wt. %, and in certain aspects, optionally greater than or equal to about 1 wt. % to less than or equal to about 10 wt. %, of the one or more binders.

The negative solid-state electroactive particles 50 (and/or second plurality of solid-state electrolyte particles 90) may be optionally intermingled with binders, such as sodium carboxymethyl cellulose (CMC), styrene ethylene butylene styrene copolymer (SEBS), styrene butadiene styrene copolymer (SBS), polyvinylidene difluoride (PVDF), polytetrafluoroethylene (PTFE), ethylene propylene diene monomer (EPDM) rubber, nitrile butadiene rubber (NBR), styrene-butadiene rubber (SBR), polyethylene glycol (PEO), and/or lithium polyacrylate (LiPAA) binders. Electrically conductive materials may include, for example, carbon-based materials or a conductive polymer. Carbon-based materials may include, for example, particles of graphite, acetylene black (such as KETCHEN™ black or DENKA™ black), carbon nanofibers and nanotubes, graphite, graphene (such as graphene oxide), carbon black (such as Super P), and the like. Examples of a conductive polymer may include polyaniline, polythiophene, polyacetylene, polypyrrole, and the like. In certain aspects, mixtures of the conductive additives and/or binder materials may be used.

The positive electrode 24 may be formed from a lithium-based or electroactive material that can undergo lithium intercalation and deintercalation while functioning as the positive terminal of the battery 20. For example, in certain variations, the positive electrode 24 may be defined by a plurality of the positive solid-state electroactive particles 60. In certain instances, as illustrated, the positive electrode 24 is a composite comprising a mixture of the positive solid-state electroactive particles 60 and a second plurality of solid-state electrolyte particles 92. For example, the positive electrode 24 may include greater than or equal to about 30 wt. % to less than or equal to about 98 wt. %, and in certain aspects, optionally greater than or equal to about 50 wt. % to less than or equal to about 95 wt. %, of the positive solid-state electroactive particles 60, and greater than or equal to 0 wt. % to less than or equal to about 50 wt. %, and in certain aspects, optionally greater than or equal to about 5 wt. % to less than or equal to about 20 wt. %, of the second plurality of solid-state electrolyte particles 92. In each variation, the positive electrode 24 may be in the form of a layer having an average thickness greater than or equal to about 10 μm to less than or equal to about 5,000 μm, and in certain aspects, optionally greater than or equal to about 10 μm to less than or equal to about 200 μm.

In certain variations, the positive electrode 24 may be one of a layered-oxide cathode, a spinel cathode, and a polyanion cathode. For example, in the instances of a layered-oxide cathode (e.g., rock salt layered oxides), the positive solid-state electroactive particles 60 may comprise one or more positive electroactive materials selected from LiCoO₂, LiNiₓMn_{y}Co_{1-x-y}O₂ (where 0≤x≤1 and 0≤y≤1), LiNiₓMn_{y}Al_{1-x-y}O₂ (where 0≤x≤1 and 0≤y≤1), LiNiₓMn₁₋ₓO₂ (where 0≤x≤1), and Li₁₊ₓMO₂ (where 0≤x≤1) for solid-state lithium-ion batteries. The spinel cathode may include one or more positive electroactive materials, such as LiMn₂O₄ and LiNi_{0.5}Mn_{0.5}O₄. The polyanion cathode may include, for example, a phosphate, such as LiFePO₄, LiVPO₄, LiV₂(PO₄)₃, Li₂FePO₄F, Li₃Fe₃(PO₄)₄, or Li₃V₂(PO₄)F₃, and/or a silicate, such as LiFeSiO₄. The positive solid-state electroactive particles 60 may include one or more positive electroactive materials selected from the group consisting of LiCoO₂, LiNiₓMn_{y}Co_{1-x-y}O₂ (where 0≤x≤1 and 0≤y≤1), LiNiₓMn₁₋ₓO₂ (where 0≤x≤1), Li₁₊ₓMO₂ (where 0≤x≤1), LiMn₂O₄, LiNiₓMn_{0.5}O₄, LiFePO₄, LiVPO₄, LiV₂(PO₄)₃, Li₂FePO₄F, Li₃Fe₃(PO₄)₄, Li₃V₂(PO₄)F₃, LiFeSiO₄, LiTiS₂, and combinations thereof. In certain aspects, the positive solid-state electroactive particles 60 may be coated (for example, by LiNbO₃and/or A₂O₃) and/or the positive electroactive material may be doped (for example, by aluminum and/or magnesium).

Although not illustrated, in certain variations, the positive electrode 24 may further include one or more conductive additives and/or binder materials. The positive solid-state electroactive particles 60 (and/or optional second plurality of solid-state electrolyte particles 92) may be optionally intermingled with one or more electrically conductive materials (not shown) that provide an electron conduction path and/or at least one polymeric binder material (not shown) that improves the structural integrity of the positive electrode 24. For example, the positive electrode 24 may include greater than or equal to 0 wt. % to less than or equal to about 30 wt. %, and in certain aspects, optionally greater than or equal to about 2 wt. % to less than or equal to about 10 wt. %, of the one or more electrically conductive additives; and greater than or equal to 0 wt. % to less than or equal to about 20 wt. %, and in certain aspects, optionally greater than or equal to about 1 wt. % to less than or equal to about 10 wt. %, of the one or more binders.

The one or more conductive materials optionally intermingled with the positive solid-state electroactive particles 60 (and/or the optional second plurality of solid-state electrolyte particles 92) may be the same as or different from the one or more conductive materials optionally intermingled with the negative solid-state electroactive particles 50 (and/or the optional first plurality of solid-state electrolyte particles 90). The one or more binders optionally intermingled with the positive solid-state electroactive particles 60 (and/or the optional second plurality of solid-state electrolyte particles 92) may be the same as or different from the one or more binders optionally intermingled with the negative solid-state electroactive particles 50 (and/or the optional first plurality of solid-state electrolyte particles 90). The second plurality of solid-state electrolyte particles 92 may be the same as or different from the first plurality of solid-state electrolyte particles 90. For example, the second plurality of solid-state electrolyte particles 92 may include sulfide-based solid-state particles, halide-based solid-state particles, hydride-based solid-state particles, and/or other low grain-boundary resistance solid-state electrolyte particles.

In various aspects, the present disclosure provides methods for fabricating electrolyte layers including porous scaffolds and a solution-processable solid-state electrolytes disposed therein. For example, an example method for forming an example electrolyte layer, like the electrolyte layer 26 illustrated in FIG. 1, may include contacting a solid-state electrolyte or precursor solution to a porous scaffold. In certain variations, the contacting may include dropping the precursor solution onto the porous scaffold, the precursor solution entering the porous scaffold via capillary force. The precursor solution may include solution-processable solid-state electrolytes like those detailed above and a solvent. The solvent may include, for example, ethyl propionate, ethanol, tetrahydrofuran, ethylacetate, acetonitrile, water, N-methyl formamide, methanol, ethanol-tetrahydrofuran co-solvent, and 1,2-dimethoxyethane.

The method may further include one or more heating steps selected to remove the solvent to form the free-standing, thin electrolyte layer. For example, in certain variations, the porous scaffold including the precursor solution may be moved through an oven having a controlled temperature. The porous scaffold including the precursor solution may be heated to a temperature greater than or equal to about 60° C. to less than or equal to about 300° C., and in certain aspects, optionally about 150° C., for a period greater than or equal to about 0.1 hour to less than or equal to about 12 hours, and in certain aspects, optionally about 2 hours. The removal of the solvent may, for example, facilitate precipitation of the solution-processable solid-state electrolyte within pores of the porous scaffold thereby forming a solid-state electrolyte layer.

In certain variations, the method for forming the example electrolyte layer may include repeating the above detailed steps (i.e., the contacting and the one or more heating steps) two or more times such that the solution containing solid-state electrolytes fill greater than or equal to about 80% to less than or equal to about 400%, and in certain aspects, optionally greater than or equal to about 80% to less than or equal to about 200%, of a total porosity of the porous scaffolds.

Certain features of the current technology are further illustrated in the following non-limiting examples.

### EXAMPLE 1

Example battery cells may be prepared in accordance with various aspects of the present disclosure.

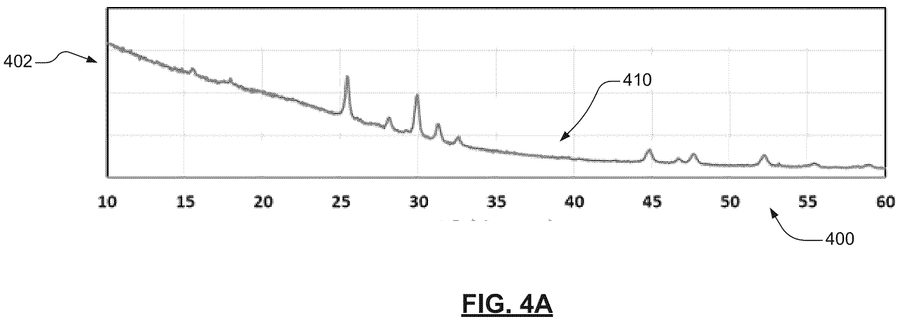

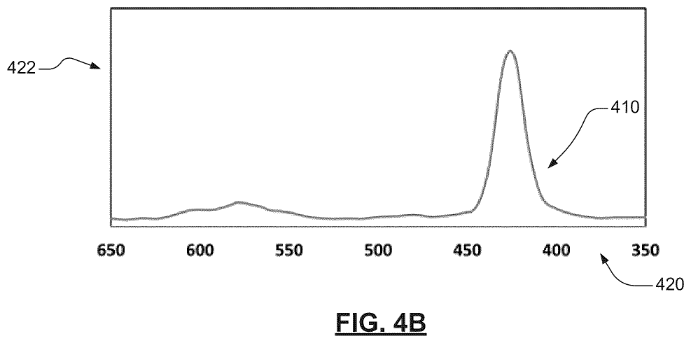

For example, an example electrolyte layer 410 may include a porous scaffold and a solution-processable solid-state electrolyte disposed therein. The example electrolyte layer 410 may have a thickness of about 14 μm and an areal conductance of about 7 mS/cm² at about 30° C. FIG. 4A is a graphical illustration demonstrating the x-ray diffraction (XRD) measurements for the example electrolyte layer 410, where the x-axis 400 represents 2θ (degrees), and the y-axis 402 represents intensity (a.u.). FIG. 4B is a graphical illustration demonstrating the Raman spectroscopy for the example electrolyte layer 410, where the x-axis 420 represents Raman shift (cm⁻³), and the y-axis 422 represents intensity (a.u.). The noted x-ray diffraction and Raman data confirms that the solution-processable solid-state electrolyte successfully forms argyrodite crystalline structures within the pores of the porous structure.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An electrolyte layer for use in an electrochemical cell that cycles lithium ions, the electrolyte layer comprises:
a porous scaffold; and
a solution-processable solid-state electrolyte that at least partially fills pores of the porous scaffold.

2. The electrolyte layer of claim 1, wherein the porous scaffold is defined by a plurality of fibers, the fibers in the plurality having an average diameter greater than or equal to about 0.01 micrometer to less than or equal to about 10 micrometers and an average length greater than or equal to about 1 micrometer to less than or equal to about 20 micrometers.

3. The electrolyte layer of claim 1, wherein the porous scaffold has a porosity greater than or equal to about 50 vol. % to less than or equal to about 90 vol. %.

4. The electrolyte layer of claim 1, wherein the porous scaffold is a high-temperature stable membrane.

5. The electrolyte layer of claim 1, wherein the porous scaffold has an average thickness greater than or equal to about 5 micrometers to less than or equal to about 40 micrometers.

6. The electrolyte layer of claim 1, wherein the solution-processable solid-state electrolyte is selected from the group consisting of: sulfide-based solid-state particles, halide-based solid-state particles, hydride-based solid-state particles, and combinations thereof

7. The electrolyte layer of claim 6, wherein the solution-processable solid-state electrolyte comprises sulfide-based solid-state particles.

8. The electrolyte layer of claim 7, wherein the solution-processable solid-state electrolyte comprises argyrodite solid-state particles.

9. The electrolyte layer of claim 1, wherein the electrolyte layer has an average thickness greater than or equal to about 5 micrometers to less than or equal to about 60 micrometers.

10. An electrochemical cell that cycles lithium ions, the electrochemical cell comprising:
a first electrode;
a second electrode; and
an electrolyte layer disposed between the first electrode and the second electrode, the electrolyte layer comprising:
a porous scaffold having a porosity greater than or equal to about 50 vol. % to less than or equal to about 90 vol. %; and
a solution-processable solid-state electrolyte that at least partially fills the pores of the porous scaffold.

11. The electrochemical cell of claim 10, wherein the porous scaffold is defined by a plurality of fibers, the fibers in the plurality having an average diameter greater than or equal to about 0.01 micrometer to less than or equal to about 10 micrometers and an average length greater than or equal to about 1 micrometer to less than or equal to about 20 micrometers.

12. The electrochemical cell of claim 10, wherein the porous scaffold is a high-temperature stable membrane.

13. The electrochemical cell of claim 10, wherein the porous scaffold has an average thickness greater than or equal to about 5 micrometers to less than or equal to about 40 micrometers, and the electrolyte layer has an average thickness greater than or equal to about 5 micrometers to less than or equal to about 60 micrometers.

14. The electrochemical cell of claim 10, wherein the solution-processable solid-state electrolyte is selected from the group consisting of: sulfide-based solid-state particles, halide-based solid-state particles, hydride-based solid-state particles, and combinations thereof.

15. A method for preparing an electrolyte layer for an electrochemical cell that cycles lithium ions, the method comprising:
contacting a precursor solution to a porous scaffold, the precursor solution comprising a solution-processable solid-state electrolyte and a solvent; and
removing the solvent to form the electrolyte layer that comprises the porous scaffold having a porosity greater than or equal to about 50 vol. % to less than or equal to about 90 vol. % and the solution-processable solid-state electrolyte at least partially filling pores of the porous scaffold.

16. The method of claim 15, wherein the porous scaffold is defined by a plurality of fibers, the fibers in the plurality having an average diameter greater than or equal to about 0.01 micrometer to less than or equal to about 10 micrometers and an average length greater than or equal to about 1 micrometer to less than or equal to about micrometers.

17. The method of claim 15, wherein the porous scaffold is a high-temperature stable membrane.

18. The method of claim 15, wherein the porous scaffold has an average thickness greater than or equal to about 5 micrometers to less than or equal to about 40 micrometers, and the electrolyte layer has an average thickness greater than or equal to about 5 micrometers to less than or equal to about 60 micrometers.

19. The method of claim 15, wherein the solution-processable solid-state electrolyte is selected from the group consisting of: sulfide-based solid-state particles, halide-based solid-state particles, hydride-based solid-state particles, and combinations thereof

20. The method of claim 15, wherein the solvent is removed by heating the porous scaffold and the precursor solution to greater than or equal to about 60° C. to less than or equal to about 300° C. for a period greater than or equal to about 0.1 hour to less than or equal to about 12 hours.
